(19) United States
(12) Patent Application Publication
(10) Pub. No.: US 2003/0107900 A1
(43) Pub. Date: Jun. 12, 2003

(54) Vehicle perimeter indicator

(76) Inventor: Thomas F. Ellison, Williston, FL (US)

Correspondence Address: Thomas F. Ellison, P.O. Box 763, Williston, FL, 32696-0763, US

(21) Appl. No.: 10/021,679

(22) Filed: Dec. 7, 2001

(51) Int. Cl. B60Q 1/26

(52) U.S. Cl. 362/485; 362/540; 362/543

(57) ABSTRACT

A device and method for precise visual indications of predetermined perimeter locations of a land vehicle is provided. The device has an electromagnetic generation mechanism for generating a high intensity, low diffusing, electromagnetic beam and a projection mechanism for securing the electromagnetic generation mechanism to the vehicle. The method of projecting the beam outward, downward, and perpendicular to the vehicle, parallel to a predetermined perimeter location provides the driver a precise visual indication of the perimeter location relative to other vehicles or obstacles. In one embodiment, the electromagnetic generation mechanism is a plurality of lasers in a phased-array projection mechanism that produce a line of beams, in the visible light spectrum, over a wide area.

### CROSS-REFERENCE TO RELATED APPLICATIONS

Not applicable.

### STATEMENT REGARDING FEDERALLY SPONSORED RESEARCH AND DEVELOPMENT

Not applicable.

### REFERENCE TO A MICROFICHE APPENDIX

Not applicable.

### BACKGROUND—FIELD OF INVENTION

The present invention relates to precise visual indications to determine an actual perimeter location of a land vehicle, in relation to other vehicles and obstacles; specifically to a high intensity electromagnetic beam projected outward, downward, and perpendicular to the vehicle at a predetermined perimeter location.

### BACKGROUND—DESCRIPTION OF PRIOR ART

Drivers of land vehicles have always been challenged to determine perimeter locations of their vehicles in relation to obstacles and other vehicles. New aerodynamically designed cars, with low profiles and rounded corners, and ever larger trucks, now with 53′ long by 102″ wide trailers, create greater challenges on increasingly crowded streets and highways.

The sheer volume of prior art speaks to the desire of drivers to know the extents, alignments, and clearance requirements of their vehicles. Dual side mirrors, enlarged rear view mirrors, corner fender mirrors, wide-angle view lenses, and vertical bumper rods have all achieved market success appealing to this desire. However, these devices obstruct other views, are difficult to use at night, and increase aerodynamic drag.

Various forms of electronic sensor devices have been developed to assist drivers avoid obstacles. These sensor types include visible light, laser, infrared, sonic, ultrasonic, and radio wave sensors. Most of these systems require a transmitter and all require a processor and indicator. This hardware and its associated wiring cause these systems to be expensive, difficult to install, and of questionable reliability. The indicators, which are outside normal scan, may distract the driver's attention.

U.S. Pat. No. 3,017,500, U.S. Pat. No. 3,435,200, U.S. Pat. No. 3,855,462, U.S. Pat. No. 4,024,497, U.S. Pat. No. 4,964,022, and U.S. Pat. No. 5,682,138 disclose lighting systems around vehicle perimeters; at axles, wheel wells, and corners. These systems use ordinary lights and are intended to illuminate a wide area. They do not give an accurate indication of the perimeter location.

U.S. Pat. No. 5,343,295 and U.S. Pat. No. 6,040,787 disclose devices that utilize the convergence of two beams on a known target area to indicate a precise distance to that area. These systems must be preset and do not give useful information away from the preset target area.

Foreign Pat. No. 4,402,661, Germany, discloses a laser beam of visible light directed rearward and downward equal to a safe distance to be observed by a following vehicle. The beam does not give indications to the driver with the device and must be adjusted for speed.

U.S. Pat. No. 5,825,305 discloses a device that projects a planer beam downwardly onto the longitudinal centerline of the loading ramp of a cargo transport aircraft. U.S. Pat. No. 5,719,568 discloses an electromagnetic beam laser at a downward projection angle, forward of vertical, such that the beam contacts the ground at a position indicating the location of the distal end of a wing of an aircraft. These devices indicate a single aspect of an aircraft and are not related to land vehicles.

U.S. Pat. No. 4,737,001 discloses a holographic indicator for determining a vehicle perimeter location. The device discloses an apparent edge of a vehicle using a substantially transparent hologram fixed to one of the windshields. The apparent edge is only accurate if the driver's head and eyes are positioned correctly. The “substantially transparent” hologram indicates that at least some distortion of the driver's view can be expected. The dependence of this device on a windshield means it would be of no use on vehicles such as forklifts and tractors.

### SUMMARY

The present invention provides a device and method for precise visual indications of a predetermined perimeter location of a land vehicle. The device has an electromagnetic generation mechanism for generating a high intensity, low diffusing, electromagnetic beam. The device includes a projection mechanism for securing the electromagnetic generation mechanism to the vehicle. The method of aiming the beam downward, outward, and perpendicular to the vehicle, parallel to the predetermined perimeter location provides the driver a precise visual indication of the perimeter location.

### OBJECTS, FEATURES, AND ADVANTAGES

The following objects, features, and advantages are met by one or more embodiments of the present invention:

It is an object of the invention to provide a device having means of generating a beam of high intensity light and means of projecting the beam downward, outward, and perpendicular to a land vehicle, parallel to a predetermined perimeter location.

It is an object of the invention that the beam precisely delineates a predetermined perimeter location of a vehicle.

It is an object of the invention that the beam is visible to a driver of the vehicle either directly or through mirrors.

It is a feature of the invention that the beam may be a laser beam in the visible light spectrum.

It is a feature of the invention that the beam may be a static discharge strobe light focused to a linear beam.

It is a feature of the invention that it may be installed as original equipment or retrofitted to a vehicle utilizing existing wiring.

It is a feature of the invention that it may be installed to delineate any desired perimeter location of any land vehicle.

It is an advantage of the invention that the beam is visible to drivers regardless of their position in their seat and may be visible to others inside or outside of the vehicle.

It is an advantage of the invention that once it is properly installed, in the desired perimeter location, no further adjustments are necessary.

It is an advantage of the invention that it becomes more effective at night, in garages, or in foul weather conditions when its indications are most needed.

It is an advantage of the invention that it does not hinder nor obstruct the driver's view.

It is an advantage of the invention that its installation or use does not create any aerodynamic drag to the vehicle.

It is an advantage of the invention that when the device is installed, indicating various perimeter locations, it provides certain beneficial information to the driver including:

(a) installation to the forward extent provides indications the vehicle:

(1) has pulled as close to an obstacle, without striking, to allow the greatest maneuverability; and

(2) has pulled close to a stop line at a stop light without blocking crosswalks; and

(3) has pulled fully into a parking space; and

(b) installation to the rear extent provides indications the vehicle:

(1) has backed close to an obstacle, without striking, to allow the greatest maneuverability; and

(2) has backed fully into a parking space; and

(3) has backed fully into a loading dock; and

(4) has backed close to a trailer or towed vehicle; and

(5) has safely cleared the front of a passed vehicle before changing lanes; and

(c) installation to the front side clearance provides indications the vehicle:

(1) is centered in a parking space or garage; and

(2) is centered and has clearance in a crowded or narrow street or alley; and

(d) installation to the rear side clearances provides indications the vehicle:

(1) is centered in a parking space when the vehicle is backing; and

(2) trailer is centered in a parking space when the towing vehicle is angled; and

(3) is properly aligned when backing to a loading dock; and

(e) installation to the perimeter location of a rear axle provides indications when the axle has safely cleared a corner or obstacle:

(f) installation to the perimeter location of a fuel filler cap provides indications when the cap is closely aligned with a fuel pump:

(g) installation to a perimeter location of a door provides:

(1) when a limousine, bus, van, or cab door is aligned with its passengers; and

(2) when a truck or delivery van door is aligned with a ramp or delivery location.

These and other objects, features, and advantages of the invention will be apparent to those skilled in the art upon consideration of the following description of the invention.

### BRIEF DESCRIPTION OF THE DRAWINGS

While the novel features of the invention are set forth in the appended claims, the invention will be better understood, along with other features there of, from the following detailed description taken in conjunction with the drawings in which:

FIG. 1 is a perspective view of a land vehicle with a set of high intensity perimeter lights illuminating the rear extent projection areas and mounting locations for the device:

FIG. 2 is a perspective view of a land vehicle with high intensity perimeter lights illuminating rear extent, rear side clearance, right forward extent, right front side clearance, and side door alignment projection areas and corresponding mounting locations for the device:

FIG. 3 is a perspective view of the components of the high intensity perimeter lights device in a multiple diode laser, phase-array embodiment:

FIG. 4 is an electrical schematic of the high intensity perimeter light device in a multiple diode laser embodiment:

FIG. 5 is a perspective view of the high intensity perimeter light in its static discharge strobe light alternative embodiment.

### REFERERNCE NUMERALS IN DRAWINGS

10 land vehicle

11 multi-lane roadway

12 rear view mirror

14 main projection means

16 projection area

17 power supply from vehicle

18 laser diode

20 voltage regulator

22 capacitor

24 resistor

26 rectifying diode

28 ground and mounting bolt

32 alternative projection means

34 strobe light

36 beam shaping lens

### Detailed Description of the Invention

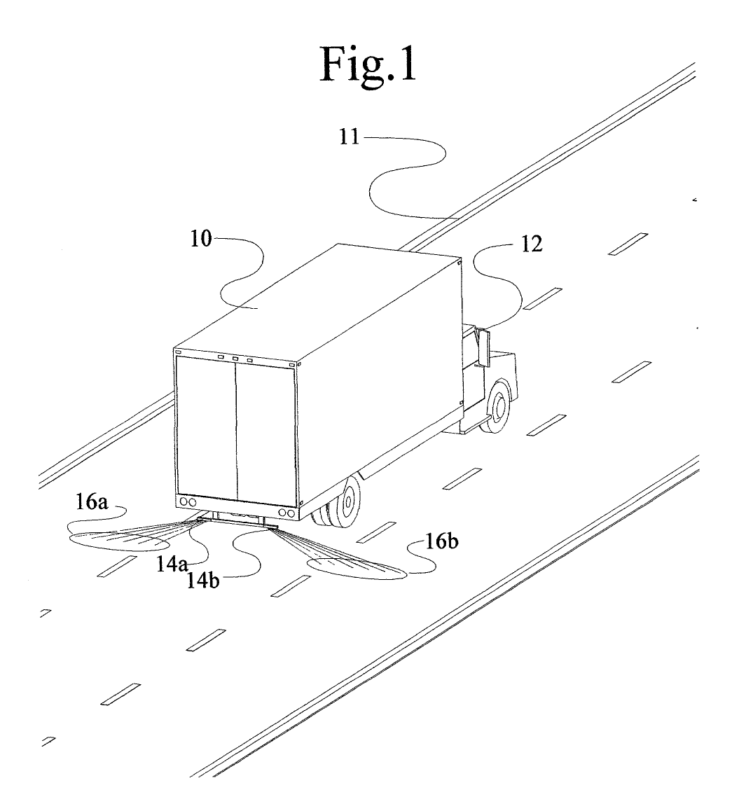

In the perspective illustration FIG. 1, a typical land vehicle 10 is depicted in the center lane of a multi-lane roadway 11. The present invention devices 14, in its phased-array multiple laser embodiment, are shown in typical mounting locations. The left rear extent device 14a is shown illuminating the left rear extent projection area 16a and the right rear extent device 14b is shown illuminating the right rear projection area 16b. These projection areas 16a, 16b are be visible to drivers of the vehicle in their normal scan of their mirrors 12.

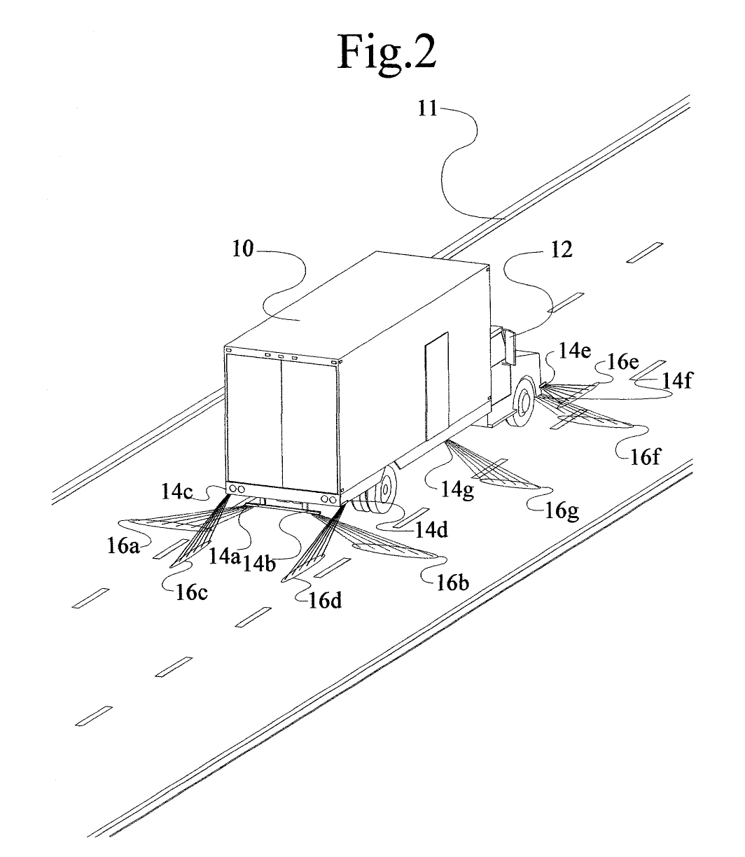

FIG. 2 illustrates the land vehicle 10 and numerous perimeter locations of the present invention device 14 and their corresponding projection areas 16, including:

(a) the rear extent devices 14a, 14b illuminating rear extent projection areas 16a, 16b.

(b) the left rear side clearance device 14c illuminating the left rear side clearance projection area 16c:

(c) the right rear side clearance device 14d illuminating the right rear side clearance projection area 16d:

(d) the right side door alignment device 14g illuminating the right side door alignment projection area 16g:

(e) the right front extent device 14f illuminating the right front extent projection area 16f:

(f) the right front side clearance device 14e illuminating the right front side clearance projection area 16e.

All projection areas 16 are visible to drivers of the land vehicle 10 in their normal scan of the roadway 11.

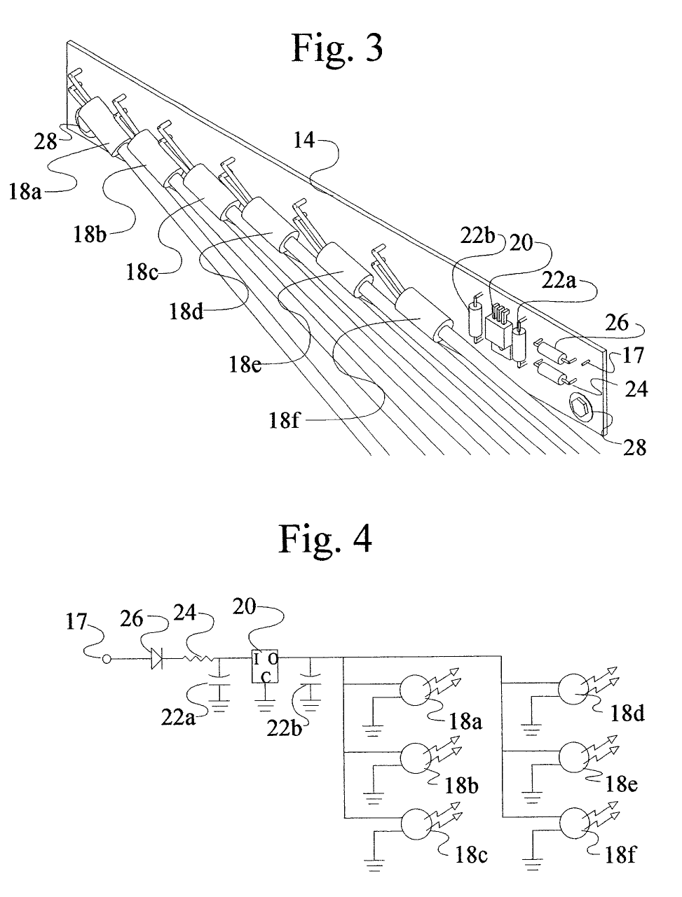

FIG. 3 is a perspective illustration of the projection means device 14 and its components 18-28 in its phased-array multiple laser diode 18 embodiment. Electromagnetic beam generating laser diodes 18a-18f are mounted in a line, parallel with the face of the projection means 14. The beam generating ends of the lasers 18 are aimed downward and laterally relative to the face of the projection means 14. Each successive laser diode 18 is aimed at a slightly more acute angle wherein the second laser 18b is aimed more acutely than the first laser 18a; and the third laser 18c is more acutely angled than the second laser 18b; and this relationship continues through the remaining lasers 18d, 18e, 18f.

The projection means 14 and its phased-array laser diodes 18 create a fan effect of the beams wherein a relatively small device 14 creates a line of images across a wide projection area 16.

The projection means device 14 includes common electronic components 20-26 to protect the laser diodes 18 from voltage spikes in the power from the vehicle's electrical system 17. FIG. 3 illustrates and FIG. 4 diagrams a rectifying diode 26, a voltage resistor 24, a capacitor 22a, a voltage regulator 20, and a capacitor 22b that combine to supply the proper voltage to the laser diodes 18. Electrical ground is supplied through the mounting bolt 28 when the projection means device is bolted to the vehicle.

The projection means 14 not only secures the electromagnetic generation means 18 to the vehicle 10, but also directs the electromagnetic beam to the desired projection area 16. The projection means device 14 should be secured to the vehicle 10 parallel with the desired projection area 16 to assure a proper indication throughout a variety of loads and road conditions. However, any parallel mounting location may be used provided the face of the projection means device 14 is angled to direct the electromagnetic beam into the projection area 16.

### Description of Alternative Embodiment

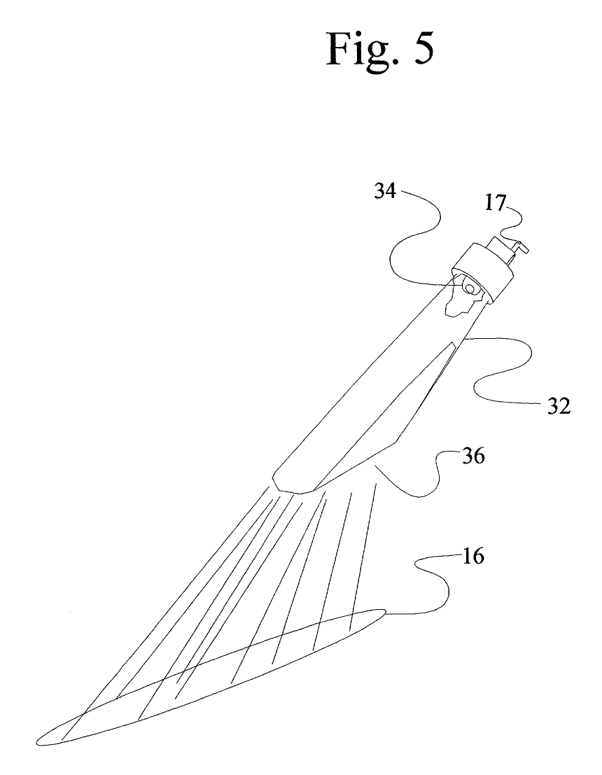

FIG. 5 shows an alternative embodiment of the present invention wherein the projection means device 32 is a hollow tube. The one end of the tube 32 is cut at an angle and fitted with a lens 36 wherein light from the electromagnetic generating means 34 is focused into a linear beam directed to the projection area 16.

The electromagnetic generating means 34 is a static discharge strobe light fitted into the opposite end of the tube 32 and supplied with current from the vehicle's electrical system 17.

Mounting locations and projection areas 16 are the same as the primary embodiment of the present invention.

### Conclusion, Ramifications, and Scope

The reader will see that the high intensity clearance requirement, alignment, and vehicle extent light provides a precise visual indication of predetermined perimeter locations. Thus it allows drivers a better understanding of their vehicle's position in relation to other vehicles and obstacles. Furthermore, the invention has the additional advantages that:

it is inexpensive and easy to retrofit on existing vehicles;

it does not create aerodynamic drag to the vehicle nor obstruct the driver's view;

its indications are visible to others inside or outside the vehicle;

it can be used at any perimeter location, on any type of land vehicle, and requires no adjustments once installed;

it is more effective when it is needed most such as at night, in garages, and in foul weather.

Although the description above contains many specificities, these should not be construed as limiting the scope of the invention but merely as providing illustrations of some of the preferred embodiments. For example, any high-intensity light may be used such as halogen, mercury-vapor, xenon, etc.; the precise indication may be a shadow or colored light within a halo of light; the light can be pulsed or steady; there may be a multiple of indicating beams; the power supply may be separate from the vehicle's; the projection means may be integral with the vehicle, etc.

Accordingly, the scope of the invention should be determined not by the embodiments illustrated, but by the appended claims and their legal equivalents.

I claim:

1. A device for precise visual indications of a predetermined perimeter location of a land vehicle, said device comprising:
at least one electromagnetic generation means for generating a high intensity, low diffusing, electromagnetic beam, wherein said electromagnetic beam is in the visible light spectrum; and
projection means for securing said electromagnetic generation means to said vehicle, wherein said electromagnetic beam is projected outward, downward, and perpendicular to the front, side, or rear of said vehicle, parallel to said perimeter location; and
whereby a precise visible image is produced on the ground or obstacles, perpendicular to said vehicle, parallel to said perimeter location.

2. The device of claim 1 wherein said electromagnetic generation means is a laser.

3. The device of claim 1 wherein said electromagnetic generation means is a high tension static discharge strobe light.

4. The device of claim 1 further including a plurality of said electromagnetic generation means. Said projection means secures each said electromagnetic generation means at slightly different lateral angles, parallel to the face of said projection means; whereby a phased-array of said electromagnetic beams are projected in a parallel line over a wide area.

5. A device for precise visual indications of a clearance requirement, alignment, or perimeter extent of a land vehicle, said device comprising:
at least one electromagnetic generation means for generating a high intensity, low diffusing, electromagnetic beam, wherein said electromagnetic beam is in the visible light spectrum; and
projection means for securing said electromagnetic generation means to said vehicle and projecting said beam outward, downward, and perpendicular to said vehicle parallel to:
(a) the left or right side of said vehicle; or
(b) the front or rear of said vehicle; or
(c) the doors, axles, or a predetermined location about the perimeter of said vehicle; and
whereby a visible image is produced on the ground or obstacles indicating said precise clearance requirement, alignment, or perimeter extent of said vehicle.

6. The device of claim 5 wherein said electromagnetic generation means is a laser.

7. The device of claim 5 wherein said electromagnetic generation means is high tension static discharge strobe light.

8. The device of claim 5 further including a plurality of said electromagnetic generation means. Said projection means secures each said electromagnetic generation means at slightly different lateral angles, parallel to the face of said projection means; whereby a phased-array of said electromagnetic beams are projected in a parallel line over a wide area.

9. A method for precise visual indications of a predetermined perimeter location of a land vehicle, comprising:
providing at least one electromagnetic generation means for generating a high intensity, low diffusing, electromagnetic beam in the visible light spectrum; and
providing a projection means for securing said electromagnetic generation means to said vehicle; and
aiming said projection means so that said electromagnetic beam is projected outward, downward, and perpendicular to the front, side, or rear of said vehicle, parallel to said predetermined perimeter location; and
whereby a precise visible image is produced on the ground or obstacles, outward and perpendicular to said vehicle, parallel to said perimeter location.

10. The method of claim 9 wherein providing a laser as said electromagnetic generator.

11. The method of claim 9 wherein providing a static discharge strobe as said electromagnetic generator.
